(19) United States
(12) Patent Application Publication
(10) Pub. No.: US 2025/0077543 A1
(43) Pub. Date: Mar. 6, 2025

(54) SYSTEMS AND METHODS FOR AUTOMATIC INGESTION OF DATA USING A RATE-LIMITED APPLICATION PROGRAMMING INTERFACE

(71) Applicant: FMR LLC, Boston, MA (US)

(72) Inventors: Travis Beaulieu, Raleigh, NC (US); Hao Fu, Dalian (CN); Changjiu Shao, Dalian (CN); Johnny Chang, Boston, MA (US)

(21) Appl. No.: 18/794,743

(22) Filed: Aug. 5, 2024

Related U.S. Application Data
(62) Division of application No. 18/238,584, filed on Aug. 28, 2023, now abandoned.

(51) Int. Cl. G06F 16/25; G06F 40/109; G06V 30/18; G06V 30/19

(52) U.S. Cl. CPC G06F 16/258; G06F 40/109; G06V 30/18019; G06V 30/1916

(57) ABSTRACT

Methods and apparatuses for automatic ingestion of data using a rate-limited application programming interface (API) include a computing device that creates structured query objects, each comprising instructions for retrieving data from a repository using the rate-limited API. The computing device requests data from the repository via the rate-limited API using the structured query objects and a plurality of API access tokens, including a) generating data requests, each comprising a structured query object; b) determining a transmission delay for each API access token based upon a current rate limit imposed by the rate-limited API; c) transmitting each data request to the repository via the rate-limited API using an API access token that has a transmission delay below a threshold value; and d) processing data received from the repository in response to each data request. The computing device repeats steps b) through d) until data responsive to each data request is received.

### RELATED APPLICATION(S)

This application is a divisional of U.S. patent application Ser. No. 18/238,584, filed on Aug. 28, 2023, the entirety of which is incorporated herein by reference.

### TECHNICAL FIELD

This application relates generally to methods and apparatuses, including computer program products, for automatic ingestion of data using a rate-limited application programming interface (API).

### BACKGROUND

Many modern computing systems rely on application programming interfaces (APIs) to expose data to, and consume data from, other computing systems. Generally, an API is a set of definitions, specifications, rules, functions, and/or protocols that enable the respective computing systems to issue calls and responses for the purpose of transferring data between them. APIs are often configured to require authentication through the use of credentials (such as an access token) before data requests are processed.

Due to the open nature of many APIs and the volume of data requests that can be received, an organization may institute one or more limits on the use of its API to prevent denial-of-service attacks, bottlenecking, and/or degradation in performance of the computing system that exposes the data. One example of an API limit is a rate limit that restricts the number of requests each account can make to the API during a given time period or the amount of data that can be retrieved during the time period. Typically, once an account reaches the rate limit, that account is unable to submit additional requests to the API until the rate limit is reset at the end of the given time period.

Such rate limits can be problematic for applications that require retrieval of large amounts of data from an API and/or applications that issue many requests to an API during a short amount of time. For example, due to rate limits, an application may only be able to request a portion of the desired data during each time period-which leads to delays in the data retrieval process and can affect downstream applications that rely on up-to-date, complete information from an API.

### SUMMARY

Therefore, what is needed are methods and systems for automatically ingesting data made available via a rate-limited API through the use of multiple different accounts and access tokens in an asynchronous manner. The technology described herein advantageously provides for asynchronous processing of data requests made to multiple repositories over a rate-limited API using unique accounts and API access tokens-which enables retrieval of data from more repositories in a shorter amount of time. In addition, the methods and systems described herein automatically account for API rate limits that may be imposed, by retrieving the remaining rate limit for a given access token and factoring the remaining rate limit into a time delay function which controls the issuance of subsequent data requests.

Furthermore, the technology beneficially provides support for pagination of retrieved data—e.g., by identifying whether a next page exists for a given API query output via a pagination value (e.g., a cursor) in the output and repeating the data fetching process using the cursor. Finally, the methods and systems described herein utilize multiple structured query objects in tandem to retrieve data from repositories—e.g., by using one or more output fields from a first structured query object as input to a subsequent structured query object.

The invention, in one aspect, features a system for automatic ingestion of data using a rate-limited application programming interface (API). The system includes a computing device having a memory for storing computer-executable instructions and a processor that executes the computer-executable instructions. The computing device creates a plurality of structured query objects, each comprising instructions for retrieving data from a repository using the rate-limited API. The computing device requests data from the repository via the rate-limited API using the plurality of structured query objects and a plurality of API access tokens, including a) generating a plurality of data requests, each comprising one of the structured query objects; b) determining a transmission delay for each of the plurality of API access tokens based upon a current rate limit for the API access token imposed by the rate-limited API; c) transmitting each data request to the repository via the rate-limited API using one of the plurality of API access tokens that has a transmission delay below a threshold value; and d) processing data received from the repository via the rate-limited API in response to each data request. The computing device repeats steps b) through d) until data responsive to each data request is received via the rate-limited API.

The invention, in another aspect, features a computerized method of automatic ingestion of data using a rate-limited application programming interface (API). A computing device creates a plurality of structured query objects, each comprising instructions for retrieving data from a repository using the rate-limited API. The computing device requests data from the repository via the rate-limited API using the plurality of structured query objects and a plurality of API access tokens, including a) generating a plurality of data requests, each comprising one of the structured query objects; b) determining a transmission delay for each of the plurality of API access tokens based upon a current rate limit for the API access token imposed by the rate-limited API; c) transmitting each data request to the repository via the rate-limited API using one of the plurality of API access tokens that has a transmission delay below a threshold value; and d) processing data received from the repository via the rate-limited API in response to each data request. The computing device repeats steps b) through d) until data responsive to each data request is received via the rate-limited API.

Any of the above aspects can include one or more of the following features. In some embodiments, determining the transmission delay comprises requesting the current rate limit for the API access token from the rate-limited API and calculating the transmission delay based upon the current rate limit. In some embodiments, the data received from the repository via the rate-limited API in response to one or more data requests comprises a pagination value. In some embodiments, when the data comprises a pagination value, the computing device stores the data in an output file that is named according to the pagination value. In some embodiments, the computing device e) generates a new data request comprising the pagination value and repeats steps b) through e) using the new data request until the pagination value indicates an end of data value.

In some embodiments, the computing device inserts one or more data elements received from the repository in response to a first data request into a subsequent data request as a query variable. In some embodiments, processing data received from the repository via the rate-limited API comprises: storing the data in a first data store; extracting one or more data elements from the data based upon one or more data processing rules; and storing the extracted data elements in a second data store. In some embodiments, extracting one or more data elements comprises removing duplicates from the data or reformatting one or more data elements.

In some embodiments, the structured query objects comprise GraphQL objects. In some embodiments, the repository comprises source code associated with a software application. In some embodiments, the data received from the repository comprises commits associated with the source code, issues associated with the source code, and pull requests associated with the source code.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for automatic ingestion of data using a rate-limited API.

FIG. 2 is a flow diagram of a computerized method of automatic ingestion of data using a rate-limited API.

FIG. 3 is a diagram of an exemplary structured query object.

FIG. 4 is a diagram of an exemplary calculation of the number of nodes queried by the structured query object.

FIG. 5 is a diagram of an exemplary process workflow performed by a server computing device to utilize data output from structured query objects as input to subsequent structured query objects.

FIG. 6 is a diagram of an exemplary data workflow for retrieving software development change data from a data repository platform.

FIG. 7 is a diagram of an exemplary data fetching and extraction workflow as performed by a server computing device.

FIG. 8 is a diagram of an exemplary data fetching and extraction workflow in Directed Acrylic Graph (DAG) format as performed by a server computing device.

### DETAILED DESCRIPTION

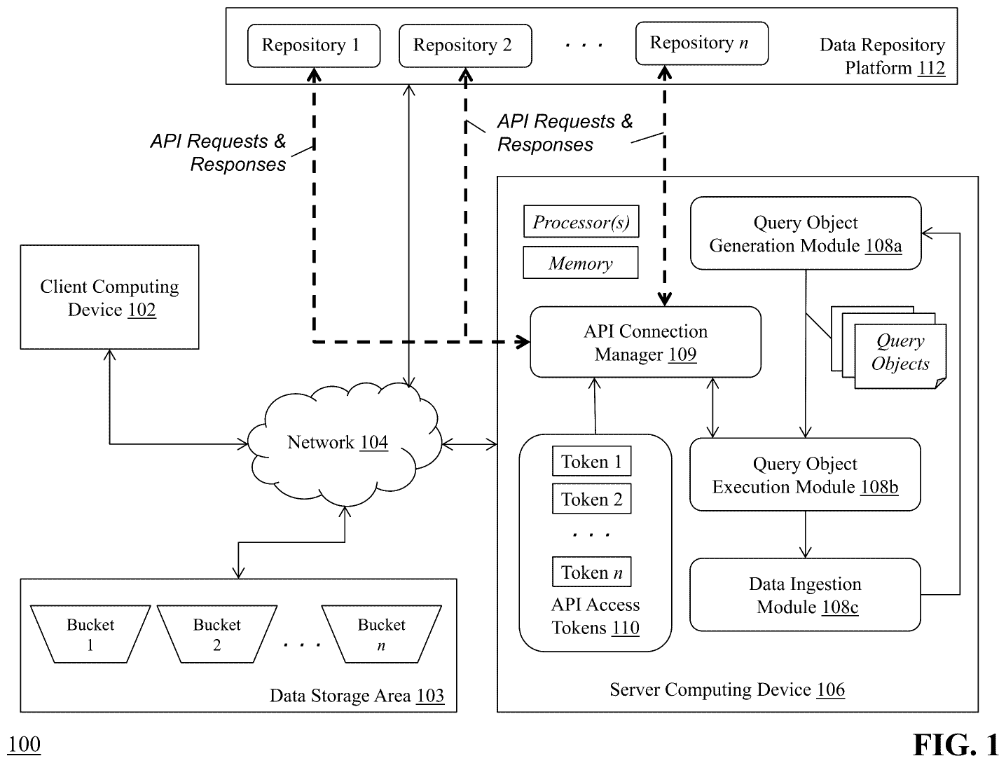

FIG. 1 is a block diagram of system 100 for automatic ingestion of data using a rate-limited API. System 100 includes client computing device 102, data storage area 103, communications network 104, server computing device 106 that includes query object generation module 108a, query object execution module 108b, data ingestion module 108c, API connections manager 109, and a plurality of API access tokens 110. System 100 also includes data repository platform 112 comprising a plurality of data repositories.

Client computing device 102 connects to communications network 104 in order to communicate with server computing device 106 to provide input and receive output relating to the process for automatic ingestion of data using a rate-limited API as described herein. Client computing device 102 can be coupled to a display device (not shown), such as a monitor or screen. For example, client computing device 102 can provide a graphical user interface (GUI) via the display device to a user of the corresponding device 102 that presents output resulting from the methods and systems described herein and receives input from the user for further processing.

Exemplary client computing devices 102 include but are not limited to desktop computers, laptop computers, tablets, and mobile devices (e.g., smartphones). It should be appreciated that other types of computing devices that are capable of connecting to the components of system 100 can be used without departing from the scope of invention. Although FIG. 1 depicts a single client computing device 102, it should be appreciated that system 100 can include any number of client computing devices.

Data storage area 103 is coupled to server computing device 106 via network 104. Data storage area 103 is configured to receive, generate, and store specific segments of data relating to the process of automatic ingestion of data using a rate-limited API as described herein. In some embodiments, at least a portion of data storage area 103 can be integrated with server computing device 106, or database platform 103 can be located on a separate computing device or devices (i.e., database server). Data storage area 103 can be configured to store portions of data received and/or used by the other components of system 100, as will be described in greater detail below. In some embodiments, data storage area 103 is located in a cloud storage infrastructure comprising one or more nodes accessible by server computing device 106. As shown in FIG. 1, data storage area 103 comprises a plurality of buckets (e.g., Bucket 1, Bucket 2, Bucket n) each of which can be configured to store certain data generated by server computing device 106 and/or data repository platform 112. An exemplary data storage area 103 is Amazon® S3 Cloud Object Storage™ available from Amazon Web Services, Inc. (aws.amazon.com/s3/).

Communications network 104 enables client computing device 102, data storage area 103, server computing device 106 and data repository platform 112 to communicate with each other for the purpose of executing the process of automatic ingestion of data using a rate-limited API as described herein. Network 104 is typically a wide area network, such as the Internet and/or a cellular network. In some embodiments, network 104 is comprised of several discrete networks and/or sub-networks (e.g., cellular to Internet).

Server computing device 106 is a device including specialized hardware and/or software modules that execute on one or more processors and interact with memory modules of server computing device 106, to receive data from other components of system 100, transmit data to other components of system 100, and perform functions for automatic ingestion of data using a rate-limited API as described herein. Server computing device 106 includes several computing modules 108a-108c that execute on one or more processors of server computing device 106. Server computing device 106 also includes an API connection manager 109 that executes on one or more processors of server computing device 106. In some embodiments, modules 108a-108c and manager 109 are specialized sets of computer software instructions programmed onto one or more dedicated processors in the server computing device 106 and can include specifically designated memory locations and/or registers for executing the specialized computer software instructions.

Although modules 108a-108c and manager 109 are shown in FIG. 1 as executing within the same server computing device 106, in some embodiments the functionality of modules 108a-108c and manager 109 can be distributed among a plurality of server computing devices. As shown in FIG. 1, server computing device 106 enables modules 108a-108c and manager 109 to communicate with each other in order to exchange data and instructions for the purpose of performing the described functions. It should be appreciated that any number of computing devices, arranged in a variety of architectures, resources, and configurations (e.g., cluster computing, virtual computing, cloud computing) can be used without departing from the scope of the invention. The exemplary functionality of modules 108a-108c and manager 109 is described in detail below.

Server computing device 106 also includes a plurality of API access tokens 110 (e.g., Token 1, Token 2, . . . , Token n). Generally, each API access token is an alphanumeric string, associated with a particular account or username, that enables server computing device 106 to authenticate to data repository platform 112 via one or more rate-limited APIs in order to retrieve data from platform 112. API access tokens 110 can be stored on server computing device 106 (i.e., in local memory) and/or on a remote computing device, including but not limited to database 103. API access tokens 110 are utilized by API connection manager 109 to authenticate to data repository platform 112 via the rate-limited API, request data from data repository platform 112 via the rate-limited API using one or more structured query objects and receive data from platform 112 in response to the requests via the rate-limited API.

Data repository platform 112 comprises one or more computing resources configured to host a plurality of data repositories (e.g., Repository 1, Repository 2, . . . , Repository n) accessible by remote computing devices—such as server computing device 106—via an application programming interface. Server computing device 106 can request data from one or more repositories in platform 112 by issuing API calls that (i) identify the repository from which the data is requested and (ii) define the particular data to be returned. In response to each API call, platform 112 transmits an API response that provides at least a portion of the requested data to server computing device 106. In order to efficiently manage the computing performance of platform 112, prevent denial-of-service attacks, and ensure the accessibility of the data stored in the repositories, the APIs used to exchange requests and responses between server computing device 106 and platform 112 are rate limited. Generally, a rate-limited API imposes one or more restrictions on the frequency of requests made to platform 112 by a given account/access token. In one example, the rate-limited API may allocate a defined number of rate limit points (also called a rate limit count) per hour to each account/access token-after which the corresponding account/access token must wait until the number of points is reset (i.e., at the beginning of the next hour) before continuing to issue data requests to platform 112. In some embodiments, the number of rate limit points is based upon a type of account and/or access token used to request the data.

One example of a data repository platform 112 used in system 100 is the GitHub™ platform (www.github.com)-which is used by a large number of organizations to store source code, files, artifacts, and other resources associated with software development projects. Generally, each organization maintains one or more repositories in the GitHub™ platform, and each repository corresponds to a specific software development project. It should be appreciated that several repositories maintained by different organizations may logically relate to a single software development project. The repositories are accessible via one or more rate-limited APIs provided by the GitHub™ platform. GitHub™ currently provides two API endpoints: a REST API and a GraphQL API. In some embodiments, different accounts/access tokens are required to access each API endpoint. In one example, when creating a GitHub™ account, users can generate a personal access token that provides for 5,000 points per hour.

As can be appreciated, the complexity of certain API calls and/or data requests can vary significantly depending upon several different factors—such as the amount of data requested, the type of data requested, the query language used to request data, among others. In order to account for query complexity, in some embodiments the number of rate limit points does not directly correspond to the number of data requests allowed for a given account/access token. Instead, platform 112 can utilize a scoring algorithm that analyzes the complexity associated with an incoming API data request and assign a rate limit point value to the data request based upon the complexity. Platform 112 then determines the number of rate limit points remaining for the requesting account/access token and processes the request when the number of points remaining exceeds the rate limit point value assigned to the request. When the number of rate points remaining is less than the assigned rate limit point value for the data request, platform 112 can prevent the data request from being processed and transmit a notification message to the requesting account/access token.

As mentioned above, the rate limit imposed by platform 112 can result in inefficiencies when attempting to retrieve large amounts of data from and/or executing complex data queries against one or more repositories. For example, it is quite possible to hit the hourly rate limit for a given GitHub™ access token with only a few intermediately complex queries. Therefore, it can take a long time to retrieve a full set of desired data-most of which is spent waiting for the access token's rate limit to reset.

To overcome this deficiency, the systems and methods described herein advantageously provide for asynchronous processing of data requests to multiple repositories in platform 112 using a plurality of unique accounts and API access tokens-which enables retrieval of data from more repositories in a shorter amount of time. In addition, the technology described herein automatically accounts for API rate limits imposed by platform 112 by retrieving the remaining rate limit points for a given API access token and factoring the remaining rate limit points into a time delay function to control the issuance of subsequent data requests for the access token. Furthermore, the systems and methods provide support for pagination of retrieved data—e.g., by identifying whether a next page exists for a given query output via a pagination cursor and repeating the data fetching process using a hash of the cursor. Finally, multiple structured query objects (e.g., GraphQL objects) can be used in tandem to retrieve data from repositories—for example, query execution module 108b can use one or more output fields from a first structured query object as input to a subsequent structured query object. Additional technical details about the operation of system 100 to achieve each of these advantages is provided below.

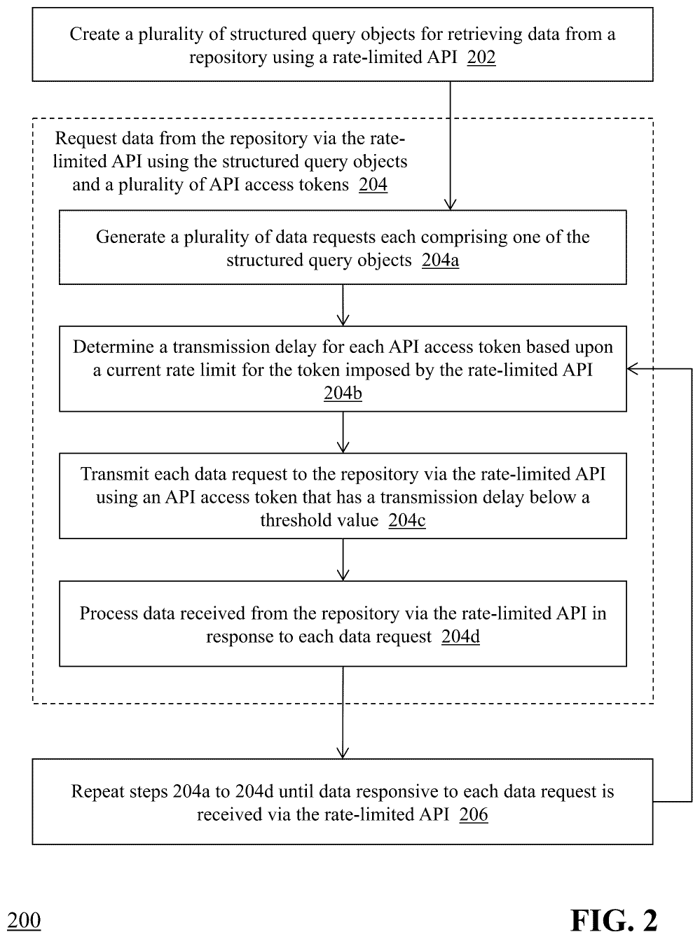

FIG. 2 is a flow diagram of a computerized method 200 of automatic ingestion of data using a rate-limited API, using system 100 of FIG. 1. The technical description below is provided using an exemplary use case, namely, retrieval of software development change data (i.e., commits, issues, pull requests) from a plurality of source code repositories in a data repository platform (i.e., GitHub™). In this exemplary use case, the goal is to retrieve data associated with development changes that are made to certain source code repositories that contain code for cryptocurrency assets, blockchain frameworks, or other decentralized computing platforms. The data can then be analyzed to determine a development activity level for each project, which is used for a variety of purposes including, but not limited to, determining a technical maturity associated with the project. By determining the technical maturity of a cryptocurrency asset's software, one can assess the viability of and market confidence in the underlying asset. However, it should be appreciated that this use case is merely intended to illustrate the technical advantages and benefits of the invention, and that the techniques described herein are equally applicable to other computing frameworks and use cases that require retrieval of data from a repository using a rate-limited API for any number of purposes.

Query object generation module 108a creates (step 202) a plurality of structured query objects for retrieving data from one or more repositories in platform 112 using the rate-limited API. In some embodiments, the structured query objects comprise GraphQL objects. Generally, GraphQL is a query language for APIs that enables users to define the structure of data requested through the use of GraphQL objects, which include one or more fields that expose data and may be queried by name. The GraphQL objects are used to retrieve data from repositories in platform 112. The GitHub™ platform is configured with a GraphQL API that enables the retrieval of data using GraphQL objects.

Module 108a passes the structured query objects to query object execution module 108b for execution. Module 108b requests an API access token from API connection manager 109 for each query object, which selects an API access token based upon the remaining rate limit points for each token. Module 108b then coordinates with connection manager 109 to generate (step 204a) a plurality of data requests, each comprising one of the structured query objects. Connection manager 109 transmits the data requests containing the query objects to data repository platform 112 for execution and retrieval of the requested data. Additional detail about the process by which API connection manager selects a particular API access token for use based upon the remaining rate limit points is provided below.

API connection manager 109 can transmit, receive, and process the data requests associated with multiple API access tokens asynchronously which improves data retrieval speed and efficiency. In some embodiments, manager 109 is configured to utilize the asyncio Python library when transmitting data requests to, and receiving data responses from, platform 112. For example, manager 109 can run a first API call for a given GraphQL query object using a first API account token to platform 112 while subsequent API calls for the same GraphQL query object can be run using other API account tokens. Additional information about the asyncio library is found at docs.python.org/3/library/asyncio.html.

As mentioned above, each API access token is allocated a certain number of rate limit points (also called a rate limit score) over a defined time period to request data from platform 112. For its REST API, GitHub™ defines a number of requests available for each access token per hour. For example, a personal access token is allocated 5,000 REST API requests per hour. However, a single relatively complex GraphQL request could be the equivalent of many thousands of REST API requests. To ensure that GraphQL queries do not overwhelm the platform 112, for its GraphQL API, instead of requests GitHub™ uses points that correspond to the number of unique connections making up a particular GraphQL query. For example, a personal access token is allocated 5,000 GraphQL points per hour.

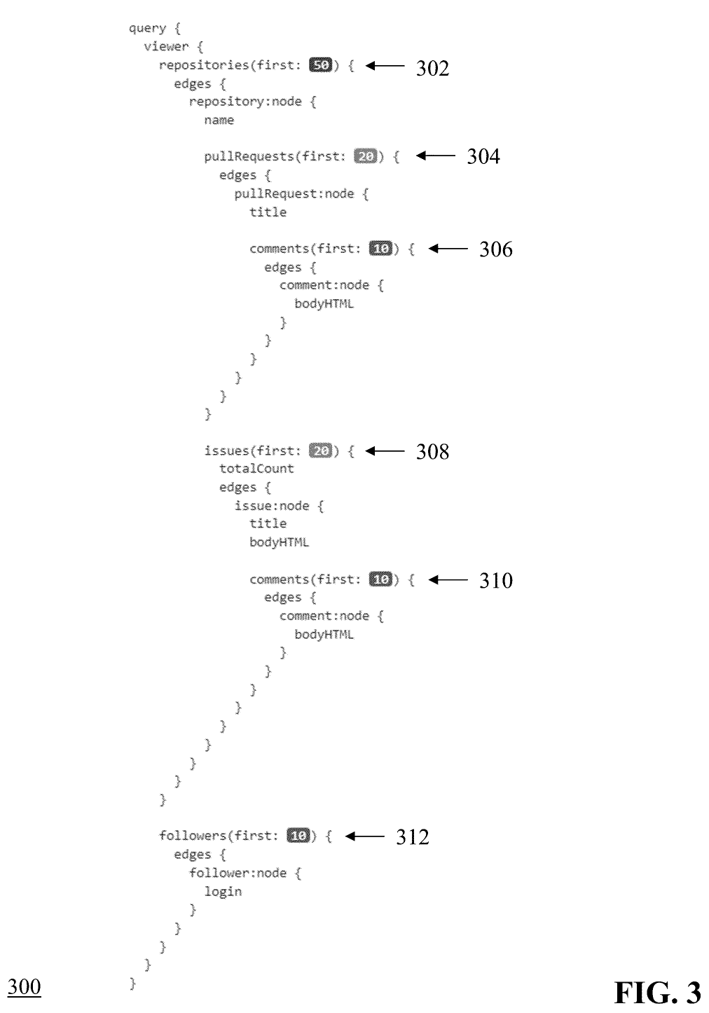

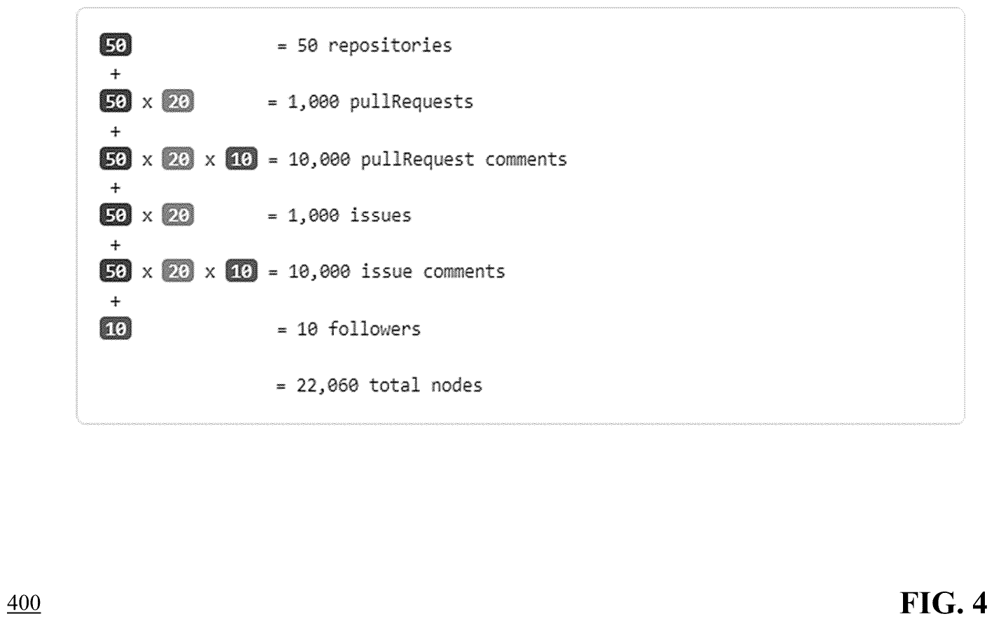

FIG. 3 is a diagram of an exemplary structured query object 300—in this case, a GraphQL object. As shown in FIG. 3, object 300 is defined as a ‘query’ type, indicating that data is read from the repository. Object 300 also identifies that it queries fifty repositories 302 for data and, for each repository, the object 300 captures certain information—such as pullRequests 304, comments 306, issues 308, comments 310, and followers 312. Each type of data in object 300 is associated with a number of nodes being requested. For example, twenty pullRequest nodes are queried for each repository. FIG. 4 is a diagram of an exemplary calculation of the number of nodes queried by object 300 in FIG. 3. As shown in FIG. 4, the total number of nodes queried is 22,060. This calculation can be used by server computing device 106 to determine a transmission delay for API access tokens 110 as will be described below.

API connection manager 109 tracks the remaining number of rate limit points for each API token and selects an API token based upon the remaining number of points in combination with a determined (or estimated) complexity value associated with the structured query object. As described above in the example of FIGS. 3 and 4, API connection manager 109 can determine that a structured query object being prepared by module 108b for execution will incur a cost of 22,060 points when executed by platform 112. Manager 109 analyzes the remaining number of rate limit points for each API access token 110 stored in server computing device 106 and selects an API access token that has enough rate limit points to successfully complete execution of the query and retrieve the requested data.

As can be appreciated, as more and more queries are generated by server computing device 106 and transmitted to platform 112 for execution, the rate limit points allocated to each API access token 110 are depleted. In order to ensure the continuous retrieval of data from platform 112, API connection manager 109 can apply a transmission delay to queries sent to platform 112 for a given API access token based upon the remaining rate limit points for the token. Upon receiving a request for an API access token from query object execution module 108b, API connection manager 109 determines (step 204b) a transmission delay for each API access token 110 based upon a current rate limit (i.e., the number of points remaining) for the token imposed by the rate-limited API and data repository platform 112.

As an example, manager 109 can determine the transmission delay for each API access token 110 using the following algorithm:
1) Determine whether the number of remaining rate limit points (R) for an API access token is less than a minimum number (M) of rate limit points needed to execute a query.
2) If R<M, set the transmission delay for the token to the time at which the rate limit resets minus the current time.
3) If R>M, set the transmission delay to zero.

As an example, a given API access token has 400 remaining rate limit points until the next reset and the minimum number (M) is set to 600. The current time is 2:30 pm and the rate limit resets every hour (i.e., the next reset occurs at 3:00 pm). Using the above algorithm, API connection manager 109 can set the transmission delay for the token to thirty minutes (3:00−2:30).

In some embodiments, API connection manager 109 is configured to retrieve the remaining number of rate limit points for a given API access token from data repository platform 112. For example, manager 109 can submit the following structured query object to the GitHub™ platform 112 to check the rate limit status for a given API access token:

```
query {
  viewer {
  login
  }
  rateLimit {
  limit
  cost
  remaining
  resetAt
  }
}
```

As shown above, the ‘rateLimit’ object includes a ‘limit’ field which returns the maximum number of points the access token is permitted to consume in a predefined period (e.g., one hour). The ‘cost’ field returns the point cost for the current call that counts against the rate limit. The ‘remaining’ field returns the number of points remaining in the current rate limit window. The ‘resetAt’ field returns the time at which the current rate limit window resets. As can be appreciated, manager 109 can perform the rate limit check for a given API access token periodically and/or immediately prior to transmitting a structured query object to platform 112 using the access token. In this way, manager 109 can determine in real time whether a given API access token has exceeded its rate limit or not. Manager 109 can store the values returned from platform 112 in a data structure to monitor and manage the use of API access tokens 110 for subsequent calls. For example, manager 109 can evaluate the transmission delay calculated for each API access token and select a token that has a transmission delay below a threshold value.

Once API connection manager 109 has selected an API access token to use with the structured query object provided by query object execution module 108b, manager 109 inserts the API access token into the corresponding data request and transmits (step 204c) each data request to data repository platform 112 via the rate-limited API (i.e., the GraphQL™ API). Platform 112 then executes the structured query object in the data request and returns the corresponding data to data ingestion module 108c of server computing device 106.

Data ingestion module 108c processes (step 204d) data received from data repository platform 112 via the rate-limited API in response to each data request. In some embodiments, module 108c outputs the raw data received from platform 112 to one or more buckets in data storage area 103 and also performs one or more data processing steps (such as extract-transform-load (ETL) operations) on the raw data. In one example, module 108c can clean, aggregate, and/or format data elements returned by platform 112 for ingestion by one or more downstream applications or computing systems.

In another example, module 108c can extract one or more data elements returned by platform 112 from execution of a first data request as input variables to a subsequent data request. This type of data extraction is particularly beneficial to accommodate pagination tasks when executing structured query objects that request large amounts of sequential data. As an example, a first structured data object may be configured to fetch the first n elements in a list. It may be desirable to generate a second structured data object that picks up where the first object left off and fetch the next n elements in the list. To accomplish this, GraphQL output can include fields that are useful to identifying and executing pagination tasks—such as a Boolean field that states whether a next page exists and/or a hashing function that assigns a hexadecimal identifier to pagination cursors. If a next page exists, query object generation module 108a can pass through the hashed cursor value for a pagination cursor as an input variable to the next structured data object. When graph query execution module 108b submits the object for execution by platform 112, inclusion of the hashed cursor value instructs platform 112 to return the next data in the pagination sequence. Data ingestion module 108c can be configured to avoid overwriting data in the event of pagination by utilizing an output file naming convention that differentiates the returned data (e.g., append a unique page number as a suffix to the file name).

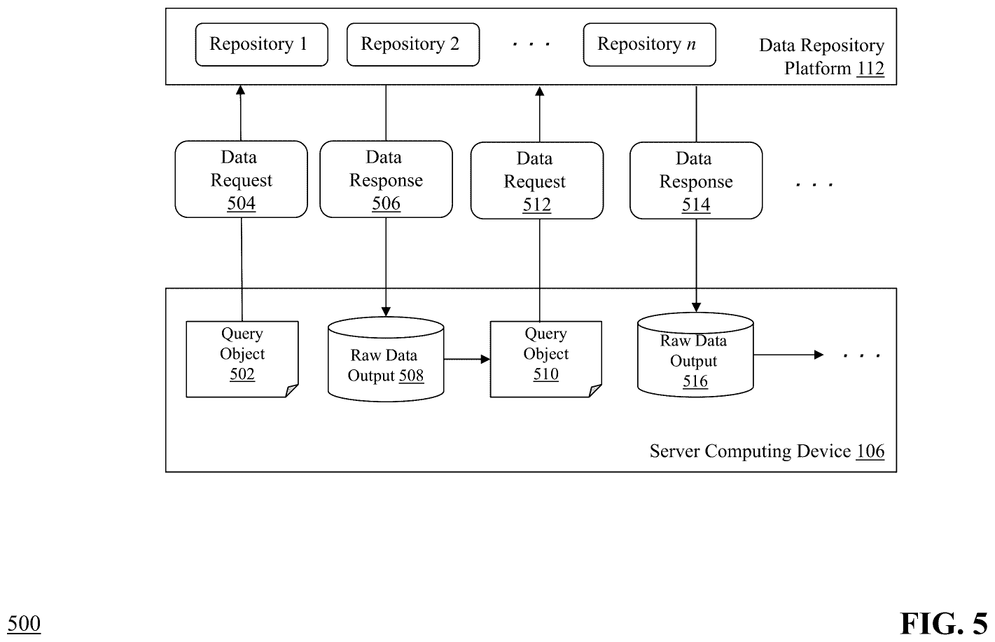

In a similar fashion, output data elements received by data ingestion module 108c can be passed to query object generation module 108a for insertion as input variables to subsequent structured data objects. FIG. 5 is a diagram of an exemplary process workflow 500 performed by server computing device 106 to utilize data output from structured query objects as input to subsequent structured query objects. As shown in FIG. 5, query object 502 is generated by server computing device 106 and transmitted to platform 112 as part of data request 504. Platform 112 executes the query object and returns data response 506 to server computing device 106 which includes raw data output 508. Server computing device 106 extracts at least a portion of raw data output 508 for use as input variables for query object 510. Server 106 transmits query object 510 to platform 112 as part of data request 512. Platform 112 executes the query object and returns data response 514 to server computing device 106 which includes raw data output 516. This process can continue for subsequent data requests and responses between server 106 and platform 112 until all data has been requested. Turning back to FIG. 2, server computing device 106 repeats (step 206) steps 204b-204d described above until data responsive to all generated data requests has been received and processed by server computing device 106.

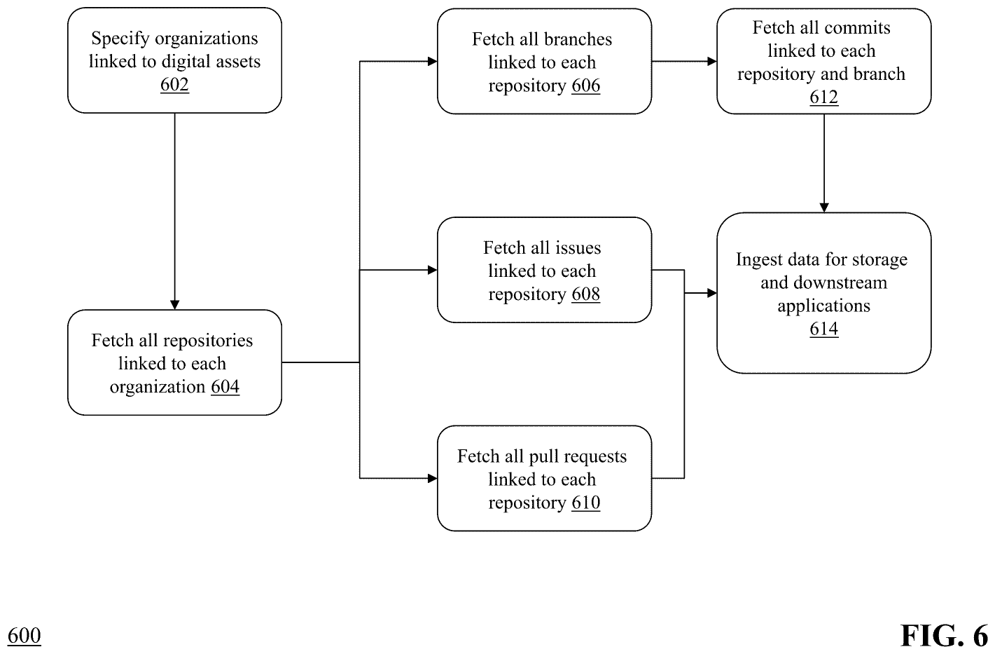

As mentioned above, an exemplary use case for the technology described herein is to retrieve data associated with changes made to certain source code repositories that contain code for cryptocurrency assets, blockchain frameworks, or other decentralized computing platforms. The data can then be analyzed to determine a development activity level for each project, which is used for a variety of purposes including, but not limited to, determining a technical maturity associated with the project. FIG. 6 is a diagram of an exemplary data workflow 600 for retrieving software development change data from platform 112.

Prior to initiating the data retrieval process, query object generation module 108a can be configured to specify (step 602) a list of organizations that maintain one or more repositories in data repository platform 112 from which data is to be fetched by server computing device 106. In some embodiments, the list of organizations can be associated with a common category or technical area (e.g., as noted above, cryptocurrency assets, blockchain frameworks, or other decentralized computing platforms). For example, the list can identify a plurality of cryptocurrency assets (e.g., Bitcoin (BTC), Ethereum (ETH)) and their associated GitHub™ organizations. The list can be generated using one or more reference sources, such as the taxonomies maintained by Electric Capital (github.com/electric-capital/crypto-ecosystems), CoinGecko/21shares (connect.21shares.com/global-crypto-classification-standard), and others. It should be appreciated that the above is merely an example and that other mechanisms to identify specific organizations and/or repositories in data repository platform 112 can be contemplated within the scope of technology described herein.

In some embodiments, query object generation module 108a creates a structured query object for each organization in the list, where the corresponding structured query object has the organization name or identifier as an input query variable, and the object is configured to retrieve as output all of the repositories that exist in platform 112 for the organization. Module 108a passes the structured query objects to query object execution module 108b for execution. Module 108b requests an API access token from API connection manager 109, which selects an API access token based upon the remaining rate limit points for each token (as described previously). Module 108b then coordinates with connection manager 109 to transmit the structured query objects to data repository platform 112 to fetch (step 604) all repositories linked to each organization.

Upon receiving the output from platform 112, data ingestion module 108c performs one or more ETL processes to extract data corresponding to each repository and instruct query object generation module 108a to create additional structured query objects for each repository in the output that are configured to retrieve all of the branches linked to each repository. Module 108b then coordinates with connection manager 109 to transmit the newly-created structured query objects to data repository platform 112 to fetch (step 606) all branches linked to each repository. Similarly, query object generation module 108a creates additional structured query objects for each repository that are configured to retrieve all of the issues linked to each repository and all of the pull requests linked to each repository. Query object execution module 108b then coordinates with connection manager 109 to transmit the newly-created structured query objects to data repository platform 112 to fetch (step 608) all issues linked to each repository and fetch (step 610) all pull requests linked to each repository. For each branch retrieved from platform 112, query object generation module 108a creates structured query objects for each branch that are configured to retrieve all of the code commits linked to each repository and branch. Query object execution module 108b then coordinates with connection manager 109 to transmit the newly created structured query objects to data repository platform 112 to fetch (step 612) all commits linked to each repository and branch. During retrieval of the above-referenced data, data ingestion module 108c ingests the data for storage (e.g., in data storage area 103) and processing by downstream applications.

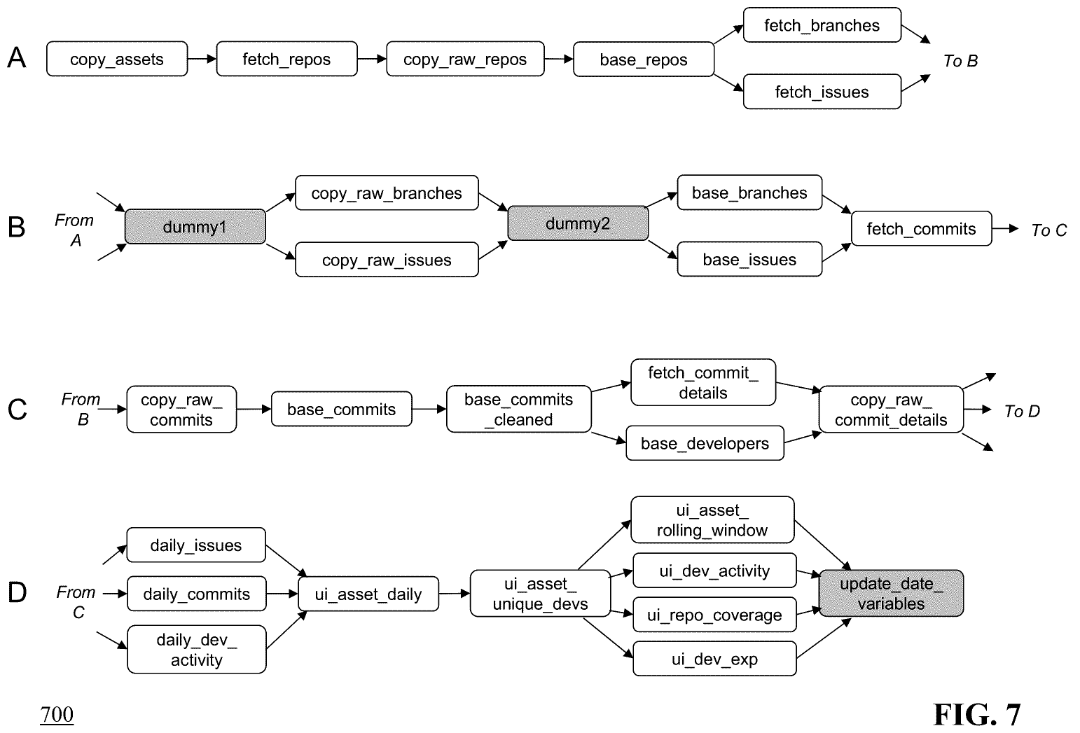

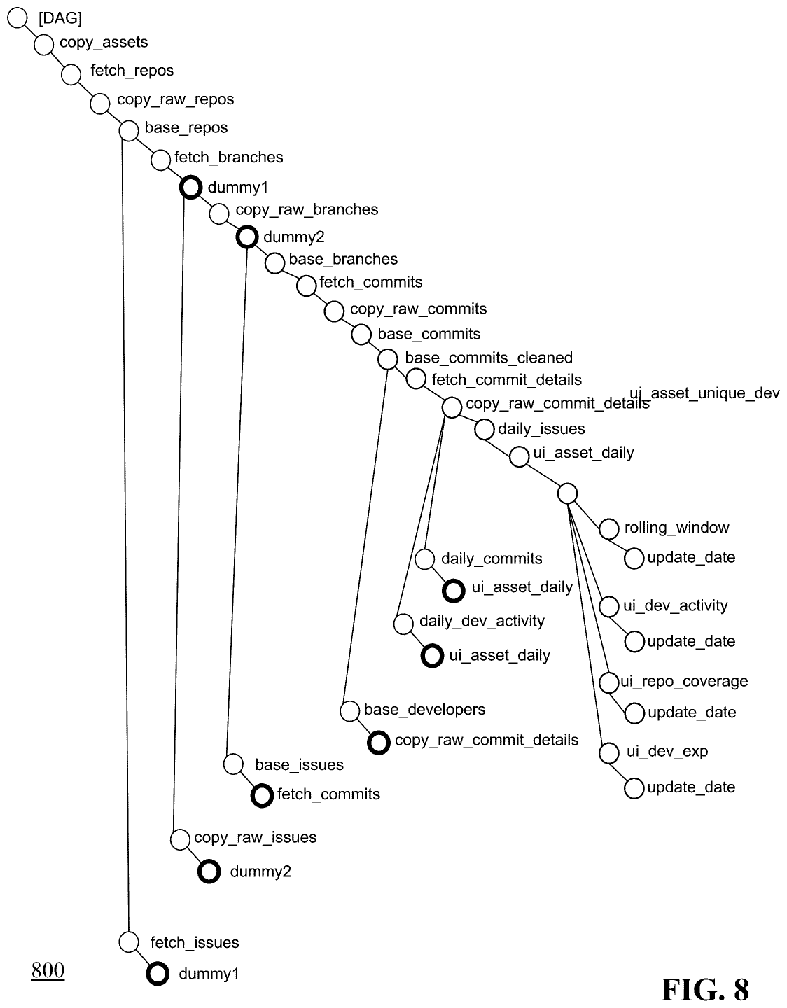

FIG. 7 is a diagram of an exemplary data fetching and extraction workflow 700 performed by server computing device 106. FIG. 8 is a diagram of the same data fetching and extraction workflow 800 represented in a directed acrylic graph (DAG) format from Apache™ Airflow™ (airflow.apache.org).

The tasks with the prefix “copy” and “base” correspond to low-level ETL processing tasks to transform raw data (e.g., JSON) received from platform 112 for storage in data storage area 103 (e.g., in AWS™ Athena tables). In some embodiments, the ETL tasks use SQL and AWS™ Athena's built-in functions to extract data from JSON objects. The tasks with the prefix “fetch” correspond to calls to GitHub™'s GraphQL API endpoint. In some embodiments, higher-level ETL processing tasks are performed in other tasks (such as. These tasks prepare data tables that are consumed by, e.g., a front end of a downstream application. Table 1 below describes the function of each task represented in FIGS. 7 and 8.

TABLE 1

| task name | function |
|---|---|
| copy_assets | formats a maintained CSV file into Parquet to instruct the next task |
| | (“fetch_repos”) which GitHub ™ organizations to search through to |
| | get the repositories whose data to fetch |
| fetch_repos | call API to fetch the repositories and associated data within the |
| | GitHub ™ organizations |
| copy_raw_repos | SQL to extract raw JSON output from fetch_repos |
| base_repos | parse through raw JSON data to get repository information in |
| | Parquet data format and stored in Athena table |
| fetch_branches | call API to fetch branches within each repository to instruct |
| | downstream queries whether to search these branches |
| fetch_issues | call API to fetch issue data for each repository |
| dummy1 | placeholder node to route back to main branch |
| copy_raw_branches | SQL to extract raw JSON output from fetch_branches |
| copy_raw_issues | SQL to extract raw JSON output from fetch_issues |
| dummy2 | placeholder node to route back to main branch |
| base_branches | parse through raw JSON data to get branch information in Parquet |
| | data format and stored in Athena table |
| base_issues | parse through raw JSON data to get issue information in Parquet |
| | data format and stored in Athena table |
| fetch_commits | call API to fetch commit data for each repository identified in |
| | previous tasks |
| copy_raw_commits | SQL to extract raw JSON output from fetch_commits |
| base_commits | parse through raw JSON data to get commit information in Parquet |
| | data format and stored in Athena table |
| base_commits_cleaned | remove duplicates, e.g., from forked repositories |
| fetch_commit_details | call API to fetch commit details data (e.g., files changed) for each |
| | commit identified in previous tasks |
| base_developers | parse through raw JSON data to get developer information in |
| | Parquet data format and stored in Athena table |
| copy_raw_commit_details | SQL to extract raw JSON output from fetch_commit_details |
| daily_issues | calculate daily metrics for issues from issue data |
| daily_commits | calculate daily metrics for commits from commit data |
| daily_dev_activity | calculate daily dev activity metrics for issues from commit details |
| | data |
| ui_asset_daily | calculate daily UI asset metrics for issues from commit details data |
| ui_asset_unique devs | calculate number of unique devs associated with UI assets from |
| | commit details data |
| ui_asset_rolling_window | calculate rolling window metrics for UI assets from commit details |
| | data |
| ui_dev_activity | calculate UI dev activity metrics for issues from commit details |
| | data |
| ui_repo_coverage | calculate UI coverage for repositories from above data |
| ui_dev_exp | SQL to extract raw JSON output from fetch_commits; removes |
| | duplicates from forked repositories |
| update_date_variables | SQL to update dates and date windows for other queries to |
| | reference |

In some embodiments, logic in the above tasks also performs data cleaning and duplication removal. Duplicates can occur when a repository is forked from another repository, which effectively carries over its codebase and commit activity. Duplicates can also occur when a code change is committed on a branch and merged into the default branch (often called “master” or “main”). In the former example with forked data, commits and their associated data are removed. In the latter example of commits that get merged, they are not removed but there is a clear indication of the branch on which the commit happened.

As can be appreciated, an important benefit of the technology described herein is the speed and efficiency with which server computing device 106 can submit API requests to platform 112—while automatically accounting for rate limits—and receive and process large amounts of data output. In the example of a cryptocurrency analytics platform, a wide range of digital assets (i.e., BTC and ETH) and their related GitHub™ development activity must be tracked. Speed, efficiency, and scale is achieved through asynchronous API request processing. As mentioned above, API requests are submitted in parallel to fetch GitHub™ data for a large number of digital assets. In addition, a plurality of unique GitHub™ accounts, each with its own API token for requests, are also run in parallel. Thus, each GraphQL query that is passed through an API request is submitted from multiple GitHub™ accounts (i.e., API tokens) and fetches data for multiple assets.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A system for automatic ingestion of data using a rate-limited application programming interface (API), the system comprising a computing device having a memory for storing computer-executable instructions and a processor that executes the computer-executable instructions to:
create a plurality of structured query objects, each comprising instructions for retrieving data from a repository using the rate-limited API;
request data from the repository via the rate-limited API using the plurality of structured query objects and a plurality of API access tokens, wherein the computing device:
a) generates a plurality of data requests, each comprising one of the structured query objects,
b) determines a transmission delay for each of the plurality of API access tokens based upon a current rate limit for the API access token imposed by the rate-limited API,
c) transmits each data request to the repository via the rate-limited API using one of the plurality of API access tokens that has a transmission delay below a threshold value, and
d) processes data received from the repository via the rate-limited API in response to each data request;
wherein the computing device repeats steps b) through d) until data responsive to each data request is received via the rate-limited API.

2. The system of claim 1, wherein determining the transmission delay comprises requesting the current rate limit for the API access token from the rate-limited API and calculating the transmission delay based upon the current rate limit.

3. The system of claim 1, wherein the data received from the repository via the rate-limited API in response to one or more data requests comprises a pagination value.

4. The system of claim 3, wherein the data comprises a pagination value, the computing device stores the data in an output file that is named according to the pagination value.

5. The system of claim 3, wherein the computing device e) generates a new data request comprising the pagination value and repeats steps b) through e) using the new data request until the pagination value indicates an end of data value.

6. The system of claim 1, wherein the computing device inserts one or more data elements received from the repository in response to a first data request into a subsequent data request as a query variable.

7. The system of claim 1, wherein processing data received from the repository via the rate-limited API comprises:
storing the data in a first data store;
extracting one or more data elements from the data based upon one or more data processing rules; and
storing the extracted data elements in a second data store.

8. The system of claim 7, wherein extracting one or more data elements comprises removing duplicates from the data or reformatting one or more data elements.

9. The system of claim 1, wherein the structured query objects comprise GraphQL objects.

10. The system of claim 1, wherein the repository comprises source code associated with a software application.

11. The system of claim 10, wherein the data received from the repository comprises commits associated with the source code, issues associated with the source code, and pull requests associated with the source code.

12. A computerized method of automatic ingestion of data using a rate-limited application programming interface (API), the method comprising:
create a plurality of structured query objects, each comprising instructions for retrieving data from a repository using the rate-limited API;
request data from the repository via the rate-limited API using the plurality of structured query objects and a plurality of API access tokens, wherein the computing device:
a) generates a plurality of data requests, each comprising one of the structured query objects,
b) determines a transmission delay for each of the plurality of API access tokens based upon a current rate limit for the API access token imposed by the rate-limited API,
c) transmits each data request to the repository via the rate-limited API using one of the plurality of API access tokens that has a transmission delay below a threshold value, and
d) processes data received from the repository via the rate-limited API in response to each data request;
wherein the computing device repeats steps b) through d) until data responsive to each data request is received via the rate-limited API.

13. The method of claim 12, wherein determining the transmission delay comprises requesting the current rate limit for the API access token from the rate-limited API and calculating the transmission delay based upon the current rate limit.

14. The method of claim 12, wherein the data received from the repository via the rate-limited API in response to one or more data requests comprises a pagination value.

15. The method of claim 14, wherein the data comprises a pagination value, the computing device stores the data in an output file that is named according to the pagination value.

16. The method of claim 14, wherein the computing device e) generates a new data request comprising the pagination value and repeats steps b) through e) using the new data request until the pagination value indicates an end of data value.

17. The method of claim 12, wherein the computing device inserts one or more data elements received from the repository in response to a first data request into a subsequent data request as a query variable.

18. The method of claim 12, wherein processing data received from the repository via the rate-limited API comprises:
storing the data in a first data store;
extracting one or more data elements from the data based upon one or more data processing rules; and
storing the extracted data elements in a second data store.

19. The method of claim 18, wherein extracting one or more data elements comprises removing duplicates from the data or reformatting one or more data elements.

20. The method of claim 12, wherein the structured query objects comprise GraphQL objects.

21. The method of claim 12, wherein the repository comprises source code associated with a software application.

22. The method of claim 21, wherein the data received from the repository comprises commits associated with the source code, issues associated with the source code, and pull requests associated with the source code.
